(19) United States
(12) Patent Application Publication
(10) Pub. No.: US 2018/0268494 A1
(43) Pub. Date: Sep. 20, 2018

(54) System and Method for Connecting and Exchanging Information between Owners of an Asset or Product, Manufacturers of the Asset or Product, Servicers of the Asset or Product and Experts on the Asset or Product

(71) Applicant: Stonepoint Technology Solutions, Inc., Hermosa Beach, CA (US)

(72) Inventor: Chad Ahrens, Hermosa Beach, CA (US)

(73) Assignee: Stonepoint Technology Solutions, Inc., Hermosa Beach, CA (US)

(21) Appl. No.: 15/719,190

(22) Filed: Sep. 28, 2017

Related U.S. Application Data
(60) Provisional application No. 62/402,241, filed on Sep. 30, 2016.

(51) Int. Cl. G06Q 50/00; H04L 12/58; H04L 29/08

(52) U.S. Cl. CPC G06Q 50/01; H04L 67/306; H04L 51/32

(57) ABSTRACT

A system for connecting and exchanging information between owners of an asset or product, manufacturers of the asset or product, servicers of the asset or product and experts on the asset or product. Each member is provided with a digital asset/product object corresponding to the asset/product that they own, customized to its classification within its industry and that stores a record of specific information for the asset or product that a customer owns. Information about that asset or product and configurations remains up to date via two-way exchange of data with other systems or data entries. Private groups and collaborations are created and managed based on asset or product classification and company. Members can share information, socialize in private and public groups, and access knowledge of subject experts and manufacturers directly or through group feeds.

### BACKGROUND OF THE INVENTION

In many industries, products or assets (the terms “product” and “asset” are used interchangeably herein, and while sometimes both terms are used together, the use of either product or asset alone is intended to embrace either a product or an asset) and their components are very valuable, owners have high expectations of product performance and service, there are large amounts of very specific product data, and a complex network of independent manufacturers and service providers. In the business aviation industry, for example, aircraft and their components are very valuable and heavily regulated, and require continuous operational and maintenance record tracking, all which is further complicated by the product mobility.

Missing in this complex system of support is a common communication tool capable of addressing multiple requirements. These requirements include, for example, immediate expert advice and access to very specific product and service information; regular data updates, storage, and data sharing with a support network that references a particular product that is owned; coordination of owners to exchange information and socialize with other owners, training and attendance at industry events centered around a common product model; collaboration between multiple manufacturers, service providers, and customers; owner feedback and improved product interaction based on data analytics, product alerts, and service offerings; improved monetization business models; integration and synchronization of social media; and closer customer relationships for all within the support network.

These needs, which are common to many products and industries, coupled with the emerging Internet of Things (IoT), inspired the present invention. Cloud computing and social media companies have focused on models such as Business to Business, Business to Employee, Business to Customer, Individual to Individual or Group, and Machine to Machine. However, until now, a model that includes multiple companies within a network or support system has not been addressed. To include multiple companies within a network or support system requires a change in the basic model as well as in complex data sharing configurations.

### SUMMARY OF THE INVENTION

The present invention provides a system and method for connecting and exchanging Information between owners of an asset or product, manufacturers of the asset or product, servicers of the asset or product and experts on the asset or product. As illustrated in FIG. 1, the present invention brings together a network/system of companies, customers, and machines, while providing many other collaborative and knowledge base features. In one embodiment, the present invention is implemented on a base cloud computing platform. One example of such a platform, as is illustrated in FIG. 2, is the Salesforce.com cloud computing platform, which provides a fully managed cloud infrastructure, in which enterprise-grade computing resources are instantly available. The Salesforce.com cloud computing platform, for example, utilizes a multitenant architecture and provides security control over user authentication and detailed administrative permissions that govern data access and data sharing. This multitenant model provides boundaries between the platform itself and applications that use the platform. Applications that use the platform are defined by their own processes (implemented as code) and collections of metadata, and have their own data objects, forms, layouts, and integrations. Customizations such as schema, code, and applications are specified as metadata, and are decoupled from the runtime environment and services of the base platform. The present invention, while utilizing the base platform, provides a unique process and data structure schema, data objects, forms and layouts.

The present invention expands on a base cloud computing platform (such as that provided by the Salesforce platform) and addresses the needs of multiple company networks that support owners and their products, for each product classification within an industry of interest. To achieve this, with reference to FIG. 3, the present invention expands the account object function to create and manage private groups based on product classification and company; private, unlisted groups, which are referred to as collaborations, per company and per user. New member invite objects enable the management of new members and new group invites for existing members. The present invention also adds member request objects that enable the new member approval process and the synchronization of contact and user record data fields. By relating the account with the digital twin of the particular product that is owned by the member—the One-Owned™ object of the present invention—records can be shared with selected accounts and private attachments can be uploaded to the member's account.

The present invention adds qualifications and certificate attachments to each user profile, and the expert object of the present invention creates a sub-list of users with an on or off line indication, capable of being sorted by geo-location. A Q&A-style technical knowledge base search page is provided that improves the interface with zones, data categories, and articles of the base cloud computing platform, such as Salesforce. A new calendar enables pubic calendar events to be displayed on a mobile application.

A common group naming protocol synchronizes groups, zones, articles, and new member requests. Data sharing between members is enhanced using public groups through a member auto-assigning process at the time of enrollment, organizing libraries and calendars. A specific user profile ensures that the application administrator (application owner) has object management access, and also ensures that each member has the correct access and share permissions to groups, topics, accounts, files, private attachments, attachments, dashboards, reports, as well as to their One-Owned™ records. The mobile application and browser pages are customized with added features; such as an on/off line indicator, follow functions and photos, and are configured to render with a consistent view. SMS texting may be incorporated into the mobile application via engagement with a Salesforce partner such as SMS Magic.

According to the present invention, an object designated as a One-Owned™ digital product object contains the business logic, database, and resulting digital product (see, e.g., FIG. 4). Data is regularly updated from sources such as the product itself, the product operating environment, social media systems, existing business systems, and external information sources. Algorithms are applied to the data and information is stored in the product database, or can be exported. The result is a digital product that opens up new ways to digitally interact with the product or its surrounding environment, improve the analytics of product condition and operations, and provides important information about product value.

The present invention assists owners in caring for their equipment and connects manufacturers and service companies to the Internet of Things (IoT). Owners can socialize in private groups and access the valuable knowledge of subject experts over mobile devices and browsers. It enables companies to digitally tap their resources of expert knowledge and interact with embedded device and system data, through a customized One-Owned™ product page created specifically for the product classification within its particular industry.

In one implementation of the invention, a “white label” IoT platform is provided, by which customers can brand their ExpertsEco™ system for their own use. Such branding may be accomplished, for example, via an industry classification naming process. For example, the naming scheme may be (product classification)(industry)(ExpertsEco). Thus, for an ExpertsEco™ system branded by a customer for use with a business jet in the aviation industry, the naming scheme may be (Business Jet)(Aviation)(ExpertsEco).

The present invention provides a new network-to-customer (N2C) connection model that links a multi-company industry network to members (customers and product owners) and their product data, essentially a system of systems. Private groups are established by product and members are invited to subscribe by the application owner and other members. The application owner may decide whether to accept new members or requests can be set to enroll members upon request. Combinations of industry network groups can be assembled based on user preferences into a single application. For example, as shown in FIG. 5, the industry network group of one application owner (Customer A) and the industry network group of another application owner (Customer B) may be combined into a single user application.

In addition, as illustrated in FIG. 6, the present invention provides a new communication model that brings together product owners and members, their product information, and manufacturing and support networks, for each product classification within its industry. Members connect with manufacturers and service expert companies through group feeds, or directly by phone, text, or email and share a common idea exchange and event calendar. Feeds may be established, for example, for the individual, company, expertise, product and topic, project collaboration, and ideas. Within the feed, information such as posts, links, photos, videos and files can be shared. The application owner may also send poll requests or announcements to members.

Specific information about an expert's qualifications and certificates and their company's capabilities are are made available along with their company's feed. Through a login and post process, posts to social media (e.g., Facebook, Twitter, Linked-In and the like) and posts to the company feed may be made, and company feed posts may be made on social media. Through a login process, synchronizations are established; posts in the ExpertsEco™ system of the present invention also appear on the social media account, and posts on the social media account appear in the ExpertsEco™ system of the present invention without user intervention. Members have access to a knowledge base for their specific product. Self-serve Q&A technical information is uniquely established and accredited to the expert/company authoring the knowledge article. All is organized by subject category defined by the application owner for the product classification within its industry. Experts of multiple companies have the ability to create private groups (which may be temporary) with other members to collaborate on projects on the company account. Conversations can take place between internal departments and across companies, may include customer members, and can be archived for later reference. Rather than learning about customers' product experiences from a handful of social media accounts and the like, all companies within the supporting network or system are now connected directly with the customers, with the actual products owned by the customers, and with the system in which the product is used.

While the aviation industry has been cited as one specific example in which the present invention may find applicability, the present invention is not limited to any specific industry, field, environment or use. For example, to provide just a few of many possible uses, the system of the present invention may advantageously be utilized in conjunction with equipment, cities and healthcare. In an application of the system to healthcare, for example, a person's body would be the asset and the private groups would be a condition common across all members.

### BRIEF DESCRIPTION OF THE DRAWINGS

FIG. 1 is a diagram of a network of companies, customers, and machines according to the present invention.

FIG. 2 is a diagram of an exemplary cloud computing platform on which the present invention may be implemented.

FIG. 3 is a diagram illustrating how the present invention expands the account object function to create and manage a private group based on product classification and company.

FIG. 4 is a diagram of a One-Owned™ digital product object according to the present invention and its interaction with the product itself, its surrounding environment, and other sources of information.

FIG. 5 depicts combinations of industry network groups into a single application according to the present invention.

FIG. 6 is a diagram of a new communication model provided by the present invention.

FIG. 7 is a diagram of the One-Owned™ digital product object according to the present invention.

FIG. 8 is a screenshot of a browser home page according to the present invention.

FIG. 9 is a screenshot of a browser event calendar page according to the present invention.

FIG. 10 is a screenshot of a browser page for requesting a new member according to the present invention.

FIG. 11 is a screenshot of a browser page for requesting another expert group according to the present invention.

FIG. 12 is a screenshot of a browser page for reviewing archived groups according to the present invention.

FIGS. 13(a)-13(c) are screenshots of mobile device event calendar pages according to the present invention.

FIGS. 14(a)-14(d) are respectively screenshots of mobile device left menu, today, personal feed and member request form pages according to the present invention.

FIG. 15 is a screenshot of a browser group feed according to the present invention.

FIG. 16 is a screenshot of a browser “topics” page according to the present invention.

FIGS. 17(a)-17(c) are screenshots of a mobile device group feed, a mobile device personal feed and a mobile device topics page according to the present invention.

FIG. 18 is a screenshot of a browser page showing connections between experts and customers according to the present invention.

FIG. 19 is a screenshot of a browser feed and overview of an expert/person according to the present invention.

FIG. 20 is a screenshot of a browser page showing qualifications and certificates that may be present on an expert/person's feed, according to the present invention.

FIG. 21 is a screenshot of an expert/person's browser account feed according to the present invention.

FIGS. 22(a)-22(c) are screenshots of mobile device expert feeds and connections views according to the present invention.

FIG. 23 is a screenshot of a browser page showing an unlisted private collaboration group according to the present invention.

FIGS. 24-25 are screenshots of browser pages showing selection and attachment of files by a collaborator to be uploaded to a collaboration feed according to the present invention.

FIG. 26 is a screenshot of a browser group page according to the present invention.

FIGS. 27(a)-27(b) are screenshots of a mobile device group page according to the present invention.

FIG. 28 is a screenshot of a mobile device subject knowledge base view according to the present invention.

FIG. 29 is a screenshot of a browser subject knowledge base page according to the present invention.

FIG. 30 is a screenshot of a browser library page according to the present invention.

FIG. 31 is a screenshot showing uploaded files from the browser library page according to the present invention.

FIG. 32 is a screenshot showing uploaded files from a mobile device library page according to the present invention.

FIG. 33 is a screenshot of a browser page showing attachment of private files to a member's account according to the present invention.

FIG. 34 is a screenshot of a browser page showing a member's notes and attachments according to the present invention.

FIGS. 35(a)-(b) are screenshots of browser pages showing a member's customizable One-Owned™ object according to the present invention.

FIG. 36 is a screenshot of a mobile device page showing the initial view of a member's One-Owned™ object according to the present invention.

FIG. 37 is a screenshot of a browser page showing sharing of a member's One-Owned™ object information according to the present invention.

FIG. 38 is a screenshot of a browser page for posting and commenting on ideas according to the present invention.

FIG. 39 is a screenshot of a browser live chat according to the present invention.

FIG. 40 is a screenshot of an application administrator/owner browser page for inviting group members according to the present invention.

FIG. 41 is a screenshot of an application administrator/owner browser page for setting up member accounts according to the present invention.

FIG. 42 is a screenshot of an application administrator/owner browser page for managing group accounts according to the present invention.

FIG. 43 is a screenshot of an application administrator/owner browser page for receiving member request forms according to the present invention.

FIG. 44 is a screenshot of an application administrator/owner browser page for creating new contacts according to the present invention.

FIG. 45 is a screenshot of an application administrator/owner browser page for inviting and adding users to groups according to the present invention.

FIG. 46 is a screenshot of an application administrator/owner browser page for viewing and managing company accounts according to the present invention.

FIG. 47 is a screenshot showing contacts, activity history and notes and attachments according to the present invention.

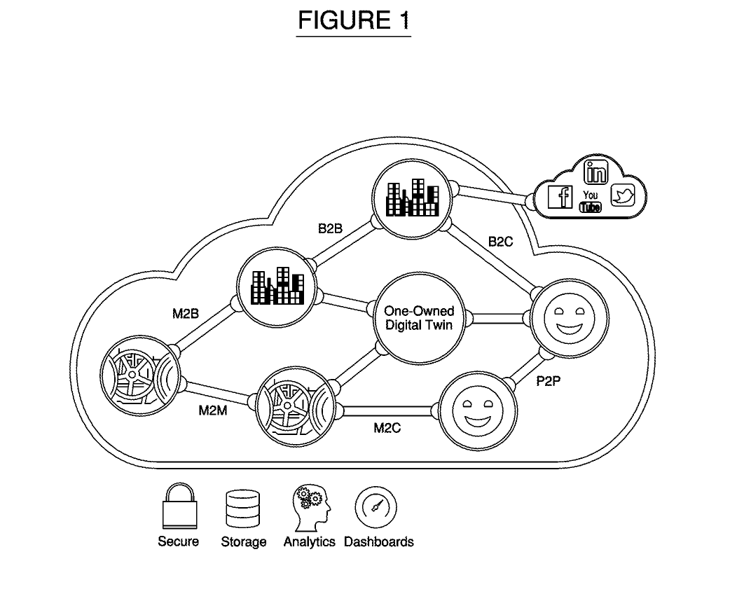

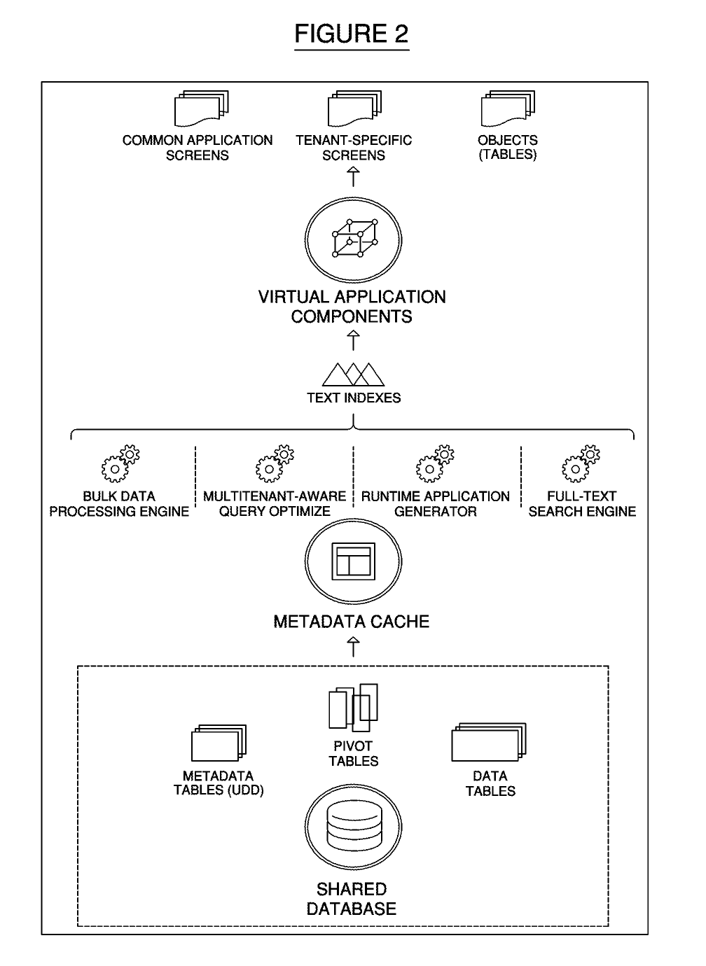

### DETAILED DESCRIPTION OF THE INVENTION

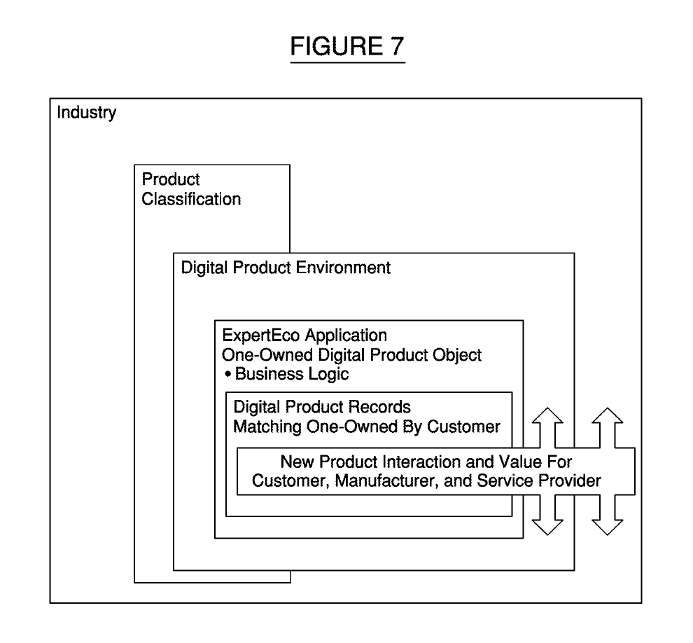

As described above, and as shown in more detail in FIG. 7, the present invention is centered around a One-Owned™ digital product object. The One-Owned™ digital product object is a cloud based object customizable for its product classification within its industry. It stores a record of specific information for the asset or assets and product or products that the customer owns, and via two-way exchange of data with other systems or through data entries, information about that asset/product and configurations remains up to date. Business logic algorithms are then applied to the One-Owned™ object, thereby facilitating new understandings of product performance and user experience.

A member that owns a One-Owned™ digital product object, as well as the application owner, have access to the One-Owned™ records concerning that digital product. Members have the option to share those records with experts on the product in question. The application owner controls the configuration, data fields, and business logic of the One-Owned™ object. Customizable reports, dashboards and product stage tracking are provided. The new digital product that is created matches (i.e. is a digital “twin” of) and expands the actual product, thereby opening new interaction possibilities for the product/asset owner, manufacturer, and service providers as well as sale marketing options.

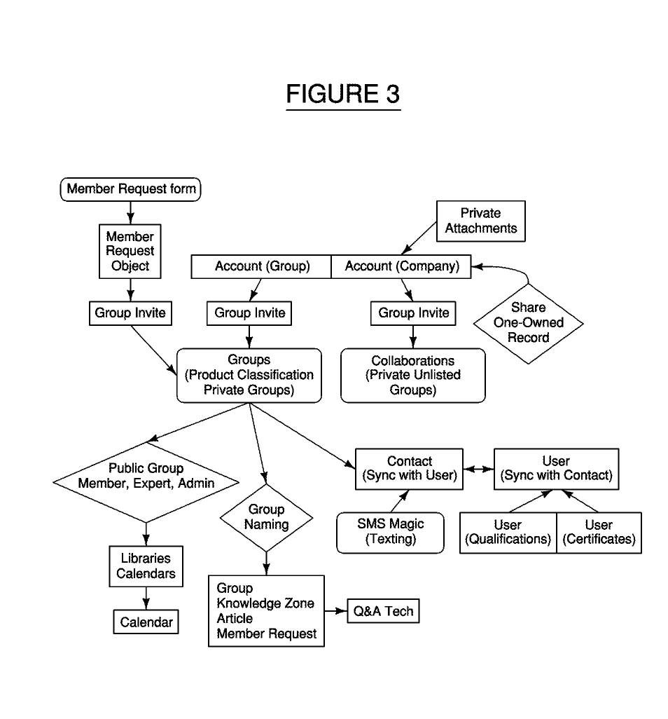

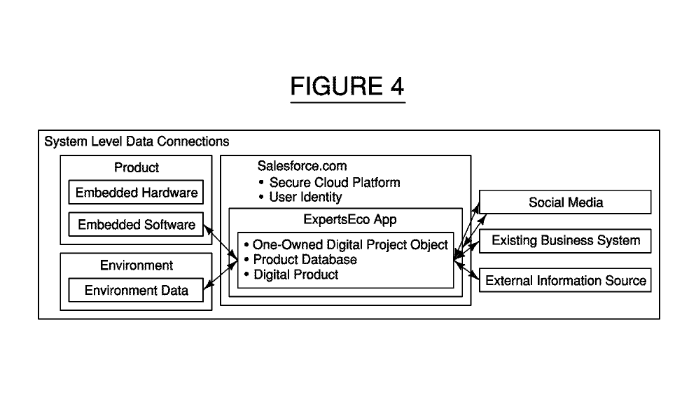

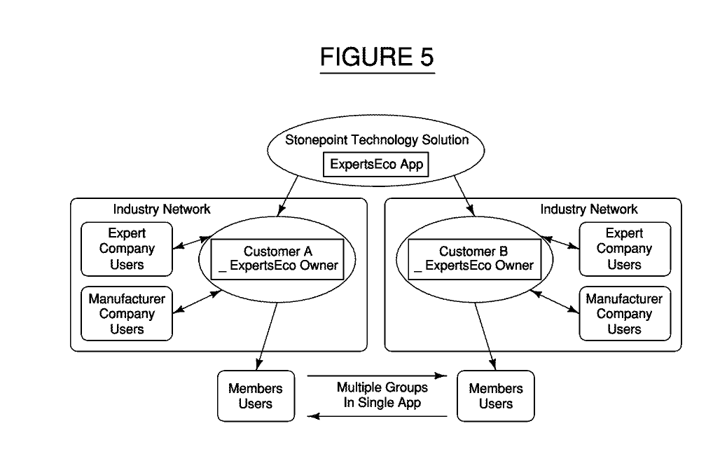

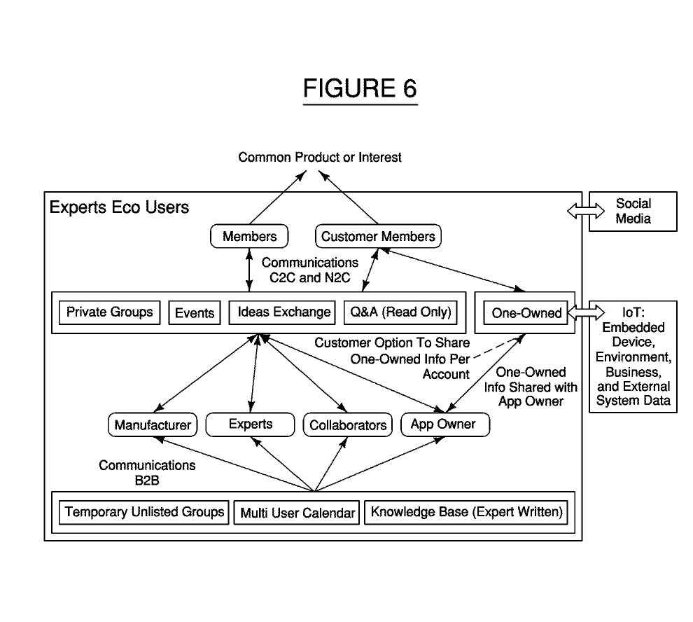

The present invention provides three member types. The owner of the application (“Application Owner”) owns and administers the application system, and maintains application membership through a member request, approval and invite process (see, e.g., FIG. 3). Experts from companies that manufacture and/or service the product (“Expert Company Members”) may also be members and provide services and support related to the product or asset, including technical support and services. Owners of the product or asset itself (“Product Owner Members”) are also members, and as owners of the same product, are provided with a network or system that unites their common interest, support needs, training and experiences. By delivery of additional product/asset value to customer members, member adoption is promoted, which is the life blood of the IoT. Upon seeing the increased value in their product, product owners will likely be more willing to provide access to product data, which can then be used to create incremental product/asset value and can be used for sales marketing.

Within the ExpertsEco™ system of the present invention, there are seven profile types associated with these three member types: Member and Customer Member (Product Owner Members); Collaborator, Manufacturer and Expert (Expert Company Members), Application Administrator and System Administrator (App Owner). These are explained in more detail below.

### Product Owner Members (Member and Customer Member Profiles)

Members are owners of a specific product or asset that unites their common interest, support needs, training and experiences.
Product owners have access to:
   1. Member feed with people, company, and topic.
   2. Product group feed.
   3. Immediate expert communication access.
   4. Specific product knowledge base.
   5. Information feed of supporting companies.
   6. Product event calendar.
   7. Product file storage.
   8. One-click product data sharing with expert companies.
   9. Creation of collaboration groups with others.
   10. Live chat.
   11. Product library.
   12. Idea exchange.

The information that is presented to Member Profiles in their browser menu and mobile menu is summarized in the following table:

| Browser Menu (Member) | Mobile Menu (Member) |
|---|---|
| Home, Personal Feed, Groups, | Today Calendar, Personal Feed |
| Event Calendar | |
| Topics | Groups |
| Q&A Tech | Topics |
| Account Companies (Private | Experts (Click directs to Contact) |
| Attachments, Activity History) | |
| Experts (Click directs to Profile) | Contacts (Click directs to Contact) |
| People (Click directs to Profile) | Q&A Tech |
| Folders (My, Shared To Group, and | Folders (Shared To Groups) |
| ExpertsEco Library) | |
| Ideas (Only available in browser) | ExpertsEco ™ Calendar |

Members having Customer Member Profiles additionally have access to a One-Owned™ page that provides two way interaction with data referencing the one product they own, and the ability to store and share the One-Owned™ records on their product with experts upon member selection of an expert company. The information that is presented to members having Customer Member Profiles in their browser menu and mobile menu is summarized in the following table:

| Browser Menu (Customer Member) | Mobile Menu (Customer Member) |
|---|---|
| Home, Personal Feed, Groups, Event | Today Calendar, Personal Feed |
| Calendar | |
| Topics | Groups |
| Q&A Tech | Topics |
| Account Companies (Private | Experts (Click directs to Contact) |
| Attachments and ExpertsEco ™ | |
| One-Owned ™ Record | |
| Shared With, One-Owned ™, | |
| Activity History) | |
| Experts (Click directs to Profile) | People (Click directs to Contact) |
| People (Click directs to Profile) | Q&A Tech |
| Folders (My, Shared To Group, and | Folders (Shared To Groups) |
| ExpertsEco Library) | |
| Ideas (Only available in browser) | One-Owned ™ |
| One-Owned ™ (Progress Bar, | Dashboard |
| Collaboration Groups) | |
| Dashboard | |
| Reports | |

### Expert Company Members (Collaborators, Manufacturers and Expert Profiles)

Expert Company Members provide services and support related to the product including technical support and services.
Expert Company Members have full function access, as well as the following functionality:
   1. Company feed write and two-way post synchronization with social media.
   2. Customer shared One-Owned™ page data.
   3. Knowledge article write capability (Expert Profile only).
   4. Creation of collaboration groups with others.
   5. Creation of public calendar events.

The information that is presented to members having Collaborator Profiles in their browser menu and mobile menu is summarized in the following table:

| Browser Menu (Collaborator) | Mobile Menu (Collaborator) |
|---|---|
| Home, Personal Feed, Groups, | Today Calendar, Personal Feed |
| Calendar, Event Calendar | |
| Topics | Groups |
| Q&A Tech | Topics |
| Account Companies (Progress Bar, | Experts (Click directs to Contact) |
| Collaboration Groups, Activity | |
| History, Notes & Attachments) | |
| Experts (Click directs to Profile) | People (Click directs to Contact) |
| People (Click directs to Profile) | Q&A Tech |
| Folders (My, Shared To Group, and | Folders (Shared To Groups) |
| ExpertsEco Library) | |
| Ideas (Only available in browser) | ExpertsEco ™ Calendar |

Members having Manufacturer Profiles can also create and maintain temporary unlisted Groups used for collaboration. The information that is presented to members having Manufacturer Profiles in their browser menu and mobile menu is summarized in the following table:

| Browser Menu (Manufacturer) | Mobile Menu (Manufacturer) |
|---|---|
| Home, Personal Feed, Groups, | Today Calendar, Personal Feed |
| Calendar, Event Calendar | |
| Topics | Groups |
| Q&A Tech | Topics |
| Account Companies (Progress Bar, | Experts (Click directs to Contact) |
| Collaboration Groups, Activity | |
| History, Notes & Attachments) | |
| Experts (Click directs to Profile) | People (Click directs to Contact) |
| People (Click directs to Profile) | Q&A Tech |
| Folders (My, Shared To Group, and | Folders (Shared To Groups) |
| ExpertsEco ™ Library) | |
| Ideas (Only available in browser) | ExpertsEco ™ Calendar |

Members having Expert Profiles provide services and support related to the product including technical support and services. Members having expert profiles also have the ability to write and publish knowledge articles, which are accredited to the expert. The information that is presented to members having Expert Profiles in their browser menu or S1 mobile menu is summarized in the following table:

| Browser Menu (Expert) | Mobile Menu (Expert) |
|---|---|
| Home, Personal Feed, Groups, | Today Calendar, Personal Feed |
| Calendar, Event Calendar | |
| Topics | Groups |
| Q&A Tech | Topics |
| Account Companies (Progress Bar, | Experts (Click directs to Contact) |
| Collaboration Groups, | |
| One-Owned ™, | |
| Contacts, Activity History, | |
| Notes & Attachments) | |
| Experts (Click directs to Profile) | People (Click directs to Contact) |
| People (Click directs to Profile) | Q&A Tech |
| Folders (My, Shared To Group, and | Folders (Shared To Groups) |
| ExpertsEco Library) | |
| Ideas (Only available in browser) | ExpertsEco ™ Calendar |
| Libraries | |
| Article Management | |

### Application Owner (App Administrator and System Administrator Profiles)

The Application Owner owns and administers the ExpertsEco system of the present invention and maintains application membership through member request approval and invite process.
The Application Owner has full function access including expert company functions, plus the ability to:
   1. Design the One-Owned™ page.
   2. Access the One-Owned™ page data.
   3. Design of analytics, dashboards, and reports.
   4. Use of data.
   5. On-board other expert companies members.
   6. On-board customer member.
   7. Polling.
   8. Announcements.

The information that is presented to members having Application Administrator Profiles in their browser menu or S1 mobile menu is summarized in the following table:

| Browser Menu (App Admin) | Mobile Menu (App Admin) |
|---|---|
| Home, Personal Feed, Groups, | Today Calendar, Personal Feed |
| Calendar, Event Calendar | |
| Topics | Groups |
| Q&A Tech | Topics |
| Account Companies (Progress Bar, | Experts (Click directs to Contact) |
| Collaboration Groups, Private | |
| One-Owned ™ Record | |
| Shared With, One-Owned ™, | |
| Contacts, Activity History, Notes | |
| & Attachments) | |
| Contacts | People (Click directs to Contact) |
| Experts (Click directs to Profile) | Q&A Tech |
| People (Click directs to Profile) | Folders (Shared To Groups) |
| Folders (My, Shared To Group, and | Dashboard |
| ExpertsEco ™ Library) | |
| Ideas (Only available in browser) | ExpertsEco ™ Calendar |
| Dashboard | |
| Reports | |
| Libraries | |
| Article Management | |
| Member Requests | |

The information that is presented to members having System Administrator Profiles in their browser menu and mobile menu is summarized in the following table:

| Browser Menu (System Admin) | Mobile Menu (System Admin) |
|---|---|
| Home, Personal Feed, Groups, | Today Calendar, Personal Feed |
| Calendar, Event Calendar | |
| Topics | Groups |
| Q&A Tech | Topics |
| Account Companies (Progress Bar, | Experts (Click directs to Contact) |
| Collaboration Groups, Private | |
| One-Owned ™ Record | |
| Shared With, One-Owned ™, | |
| Contacts, Activity History, | |
| Notes & Attachments) | |
| Contacts | People (Click directs to Contact) |
| Experts (Click directs to Profile) | Q&A Tech |
| People (Click directs to Profile) | Folders (Shared To Groups) |
| Folders (My, Shared To Group, and | Dashboards |
| ExpertsEco Library) | |
| Ideas (Only available in browser) | ExpertsEco ™ Calendar |
| Dashboard | |
| Reports | |
| Libraries | |
| Article Management | |
| Member Requests | |

In addition, the system of the present invention provides the following features:

### Menus and Security (Mobile and Browser) Per Profile

Navigation Menus (dependent on member profile type, as described in the tables above).
Security—Who sees what and when (dependent on member profile type).
Account open to list view.
Contacts open to list view.

### Filters

Only private groups and private unlisted groups that the member has joined appear as available.
Only topics within groups that the member has joined appear as available topics.
Private groups based on product classification appear as available on the group list.
Unlisted private collaboration groups are limited from appearing on the available group list.

### Public Event Calendar

Enables user visibility to public events on mobile and browser.
Enables event write and edit capability for expert company members.

### Public Library

Associates public group with public libraries.
A process is provided by which new users are assigned to public groups.
The public library appears on Files/Folders.

### People/User Profile Associated Objects and Links

Qualifications.
Certificates.
Account link and access to account logo, social media links and account feed.

### Experts

Expert name and company/account name listed for each expert.
Live on/off line indicator is provided for each expert.
On the click of the browser expert detail redirects to people/user details.
On click of the mobile expert detail redirects to contact details.

### Contact Enhancements

On mobile, contact name and company/account name are listed.
On mobile, contact photo is included.
On click of browser contact detail redirects to people/user details.
On click of mobile contact detail redirects to contact details.
Region (Roll) field and set to default as “World”.
Profile field.
Expert field.
Email attachment function.
Geo location.
Limitations on user visibility of notes and attachments—user must own to be visible.
Member Invite process fields (ExpertEco™ User, Related User, Contact From Member Request, Member Request link)
ExpertsEco™ Certification attachment section

### Group Listing

Group photo and group name listed for each group.

### Feed Enhancements

Feed post requires #Topic

### Topics

Group photo, topic name, and group name listed for each topic.
“People Talking” count is associated with each topic.
Follow option is associated with each topic.

### Mobile Today Page Enhancements

Personal feed.
Member request form.

### Q&A Tech for Mobile and Browser

Post and article filtering capability by zone/product classification group, and data categories.
Photo and name appears on expert posts and does not appear on member posts.
   Process to Enable One Private Unlisted Collaboration Group. Per Account. Per Opportunity. And Per One-Owned Record for Each User
Collaborations.
Collaboration Groups.

### Account Enhancements

Push of company account feed posts to external social media accounts.
Pull of social media account post into company account feed.
Collaboration progress status bar for account/company collaborations.
Private attachments section for member and customer member profiles.
One-Owned™ section listing records corresponding to the user's actual products.
One-Owned™ record share with section to allow product owner to share records with selected expert companies/accounts.

### Group Account and Naming Associations

Zones.
Set zone parameters (active: X, username format; first name+last name, show in: internal only: X, enable for chatter answers; X, experts group; experts).
Member request picklist
Articles picklist.
Q&A Tech zones picklist.

### Member Invite/Group Invite

Member request record.
Private groups/product classification groups.
Private unlisted collaboration groups.

### Member Request Objects and Pages

Member request form.
Member request object.
Member invite/group invite.

### New Member and Member Invite to Group Processes

User records must have a contact/account record to become members.
New members are granted access by Application Administrator approval.
Company account and group account record types.
Create new contact process from member request record.
User assignment to contact process.
Contact assignment to user process.
Account search and upload of account contacts/member for possible selection to join group.
Toggle that shows all users or shows only contacts on selected accounts.
User and contact field data synchronization. For example:
   (About: first name, last name, nickname, title, manager, about me)
   (Contact: email, mobile and work phones, fax, address, city, state, zip, country)
Delete contact and inactivate user process.
Duplicate email addresses not allowed; save of member request form, contact, and user records.

### Invite Entities Stage Progressions

1) No Entity—Member request record without user or contact record.
2) User—has only Salesforce user record. User record field values:
   ExpertsEco User—False
   Sync with Contact Roles—False
   Related Contact—Null
   ExpertUser—Null
3) Contact—has only Salesforce contact record. Contact record field values:
   ExpertsEco User—False
   InvitedGrouplist—Null
   Related User—Null
   Contact From Member Request—Null ambiguous
4) ExpertsEcoUser—has only Salesforce user record (associated contact records with user records at time of application install). User record field values:
   ExpertsEco User—True
   Sync with Contact Roles—False
   Related Contact—Null
   ExpertUser—Expert
5) ExpertsEcoContact—has only Salesforce Contact record (associated user record needed). Contact record field values:
   ExpertsEco User—True
   Related User—Null
   Contact From Member Request—True (click “Create Contact” button on member request record, is checked when contact record is saved)
6) ExpertsEcoMember—New, has Salesforce User and Contact record
   User record field values:
      ExpertsEco User—True
      Sync with Contact Roles—True
      Related Contact—Contact ID
      ExpertUser—Expert
   Contact record field values:
      ExpertsEco User—True
      Related User—Link to User record
      Contact From Member Request—True

### New Member and Member Invite to Group Processes

User is assigned to public group on creation.
User and contact field data synchronizations:
   (About First Name, Last Name, Nickname, Title, Manager, About Me)
   (Contact: Email, Mobile Phone, Work Phone, Fax, Street, Address, City, State, Zip, Country)
Deletion of contact inactivates user.

### User, Contact and Member Validations

In order to add a user (“Add Users” button), a user must be included in one of the following public groups:
ExpertsEco Admin
ExpertsEco App Admin
ExpertsEco Experts
ExpertsEco Members
   Duplicate email address are not allowed on save of:
Member Request Form
Contact
User

### Expert Qualifications

User is placed on the Expert list when:
   (Contact: “Is Expert”—True; “Expert User”—True)
Expert company is placed on the account section “Own-Owned Record Shared With” multi-pick list when:
   (Contact: “Is Expert”—True; “Expert User”—True; “Profile”—ExpertsEco Expert)
Expert geo location is calculated based on contact address when:
   (“Address” is entered and “Is Expert”—True)

### Initial Member Enrollment Process (Using Member Request Record)

1. Member request form is submitted.
2. A member request record is opened by the application administrator.
   Field values: “Created Contact”: unchecked; “Invite Contact”: unchecked; “Group Requested Date”: null
   The user is not listed in new member or in related contact sections.
3. A contact is created on member request (“Create Contact” button is clicked).
   Contact field values:
      The “Region” (Role) field defaults to “World” and can be set as needed.
      Profile is set as needed.
      Contact record is saved.
   Read Only field values:
      ExpertsEco User—False
      Related User—Null
      Contact From Member Request—True
4. A Member Request Record is created (“Member Request Record” link is clicked. The Member Request field values are:
   “Created Contact” is checked.
   “Invite Contact” is unchecked.
   “Group Requested Date” is null.
   The contact appears on new member list; Entity is “ExpertsEcoContact”.
   The contact appears in the new member and in related contact sections.
5. The user is added (on Member Request record, “Contact Action” is selected for new member, and “Add User(s)” is clicked).
   In the new member section, the Entity is set as ExpertsEcoContact.
   A welcome email is sent to the new member.
   The new member is in placed the private group that was selected.
   After the user is added (by click of the “Add User” button), the entity is changed to ExpertsEcoMember.
Contact field values:
   ExpertsEco User—True
   Related User—User Name
   Contact From Member Request—True

### Member Request to Join Active Private Group (by Requesting Another Expert Group)

1. From the home page, the user requests to join an active private group by selecting “Request Another Expert Group”.
   An email request is sent to the group owner.
   The request does not appear as a member request record.
2. Email “View Request”, on click opens Group requested and Add/Remove Members page.
3. App Admin clicks “Accept” or X
4. User receives Welcome To Group email
5. On click of “View” Member sees Group, New Topic posts will appear as posted

### User Request to Join Private Group Made by ADD Administrator (by Using Group Account “Member Invite”)

1. App Administrator selects private group account
2. App Administrator views new member section (via “Member Invite” button).
3. App Administrator selects user in New Members section (Entity is “ExpertsEcoMember” and “Add User(s)” button is clicked).
4. User receives welcome email and can now see group.
   Insert Member into Private Unlisted Group (Via Company Account “Member Invite” Button)
1. Available members are uploaded by selecting member's company account.
2. A member is selected to invite.
3. The user is added (for example, by clicking “add user(s)” button”)
   The member is added to the group.
   A welcome email is sent to the member.

### App Administrator Creates New Account and Private Group

1. New group account is selected (for example, by clicking New Group Account).
2. New account and new group are created, as well as a collaboration record.
3. The option to invite members is selected (by clicking “Member Invite”).
4. Members are selected and added (by clicking “Add User(s)”).

### App Administrator Creates New Company Account and Unlisted Group

1. New account is selected (by clicking “New Account”).
2. Group is set (by clicking “Set Group”).
3. A collaboration record is created.
4. The option to invite members is selected (by clicking “Member Invite”).
5. Members are selected and added (by clicking “Add User(s)”).

### Invitation of Non-Members Using “Invite People” on Company Unlisted Group

1. A user is created based on an email address.
2. The profile is set to: “Chatter External User”.
3. The user type is set as “CSN Only”.

According to the present invention, as discussed above, multiple user profile types are created. In one implementation, these include:
ExpertsEco Member
ExpertsEco Customer
ExpertsEco Collaborator
ExpertsEco Manufacturer
ExpertsEco Expert
ExpertsEco App Admin

In addition, in order to carry out the present invention, multiple types of objects are created. In one implementation, the types of objects created include:
Account Groups; used to establish and organize groups.
Collaborations; used to establish temporary groups.
Collaboration Group; used to organize temporary groups per account per user.
ExpertsEco Certification; used to store certificate documents.
ExpertsEco Private Files & Attachments; used to store member product documents.
Member Request; used to process new member licenses and group placement.
One-Owned™; used to store and update user's specific product information.

### Implementation as a Software Application

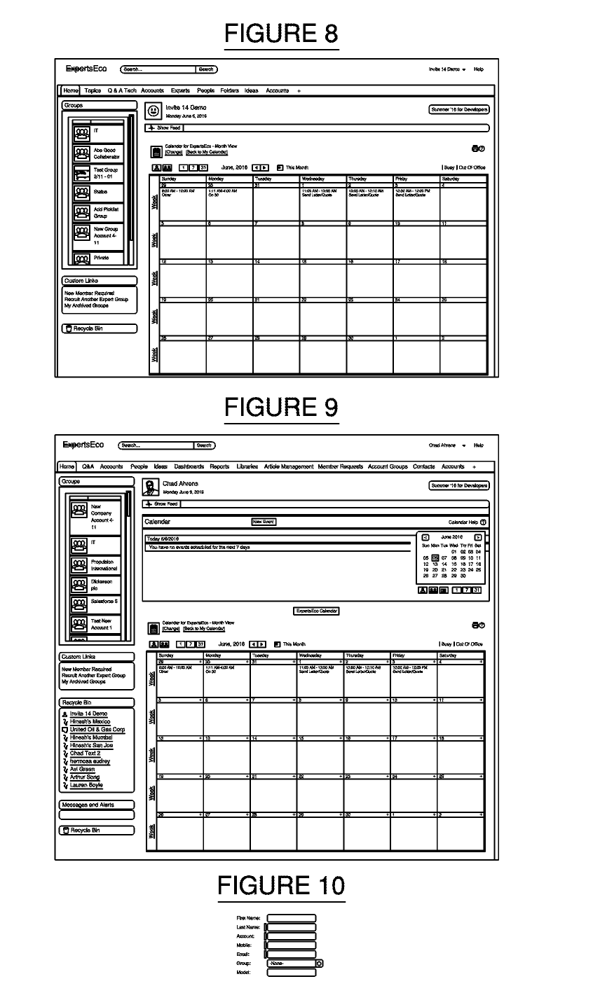

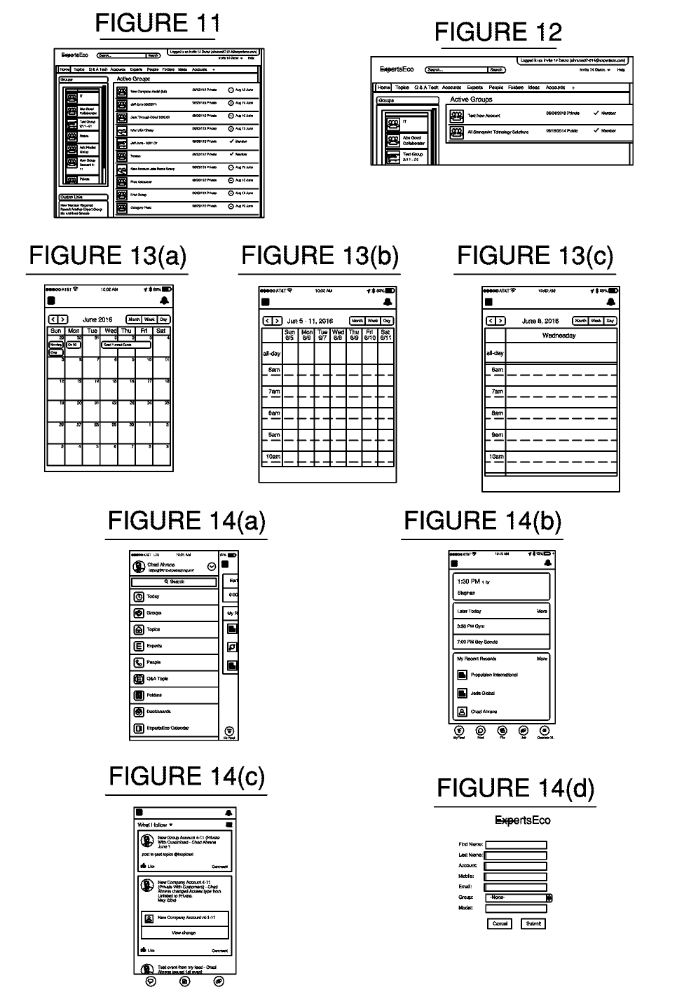

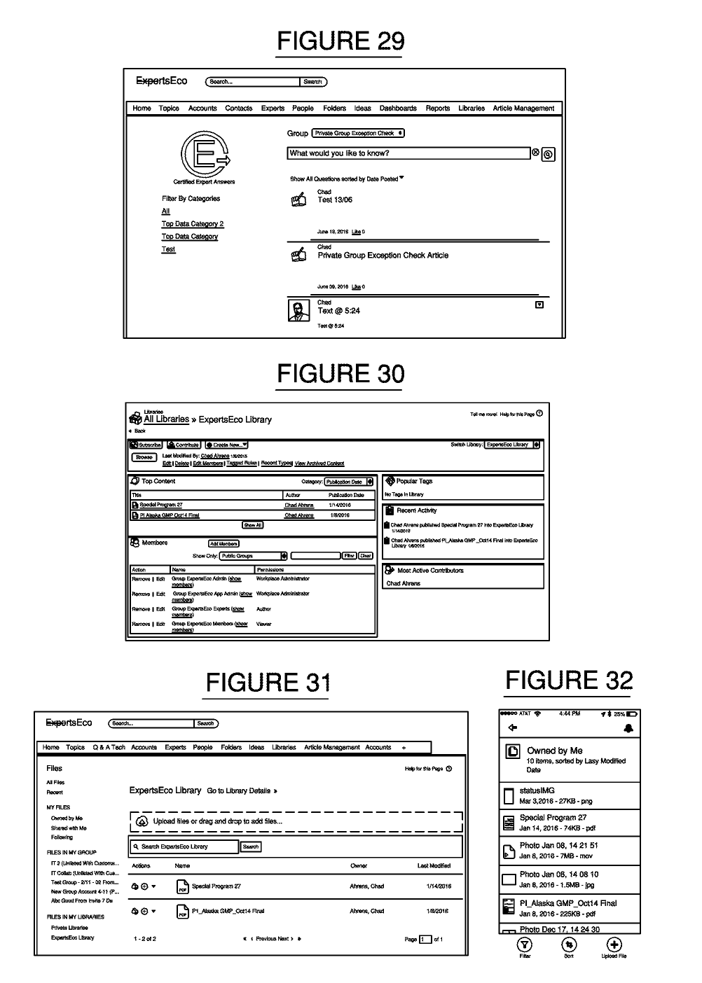

The present invention may be implemented, in one embodiment, as software on a personal computer browser or as a software application on a mobile device. The system has both mobile and community technical capability. FIGS. 8-46 are exemplary screenshots of such a software application as implemented in either a browser of a personal computer or in an application on a mobile device. FIG. 8 is a screenshot of a browser home page that shows, for example, available groups, a public calendar, and a personal feed. FIG. 9 is a screenshot of a browser event calendar page. In this regard, expert companies have a personal calendar and can write to the event calendar. FIG. 10 is a screenshot of a browser page for requesting a new member that links to and opens a new member request form. FIG. 11 is a screenshot of a browser page for requesting another expert group, by which members can request to join other groups. FIG. 12 is a screenshot of a browser page for reviewing archived groups, by which group conversations that are no longer active can be reviewed.

FIGS. 13(a)-13(c) are screen shots of an event calendar as viewed on a mobile device. FIG. 14(a) is a screen shot of a left menu for a mobile device application that provides access to all features. FIG. 14(b) is a screen shot of a today page for a mobile device application that opens the user's calendar items for the day and shows recently accessed items. FIG. 14(c) is a screen shot of a personal feed for a mobile device application. FIG. 14(d) is a screen shot of an ExpertsEco member request form.

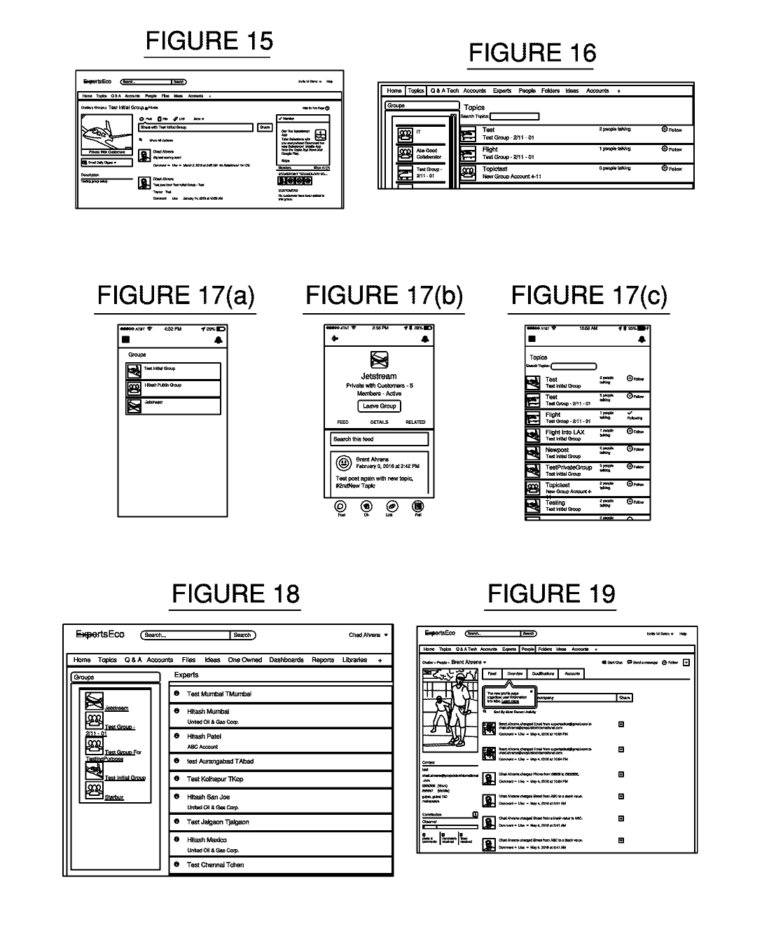

FIG. 15 is a screen shot of a browser group feed. The group feed may include, for example, posts, photos, videos, files and links. In addition, the application administrator may send polls and announcements to the groups. Only groups and topics of which the user is a member appear in the browser group feed of FIG. 15. As shown in FIG. 16, which is a screen shot of a “Topics” page in the browser personal feed, topics can be selected to be followed in the personal feed, and can be sorted by member activity. FIGS. 17(a)-17(c) are screen shots showing a group feed, personal feed and topics as viewed on a mobile device.

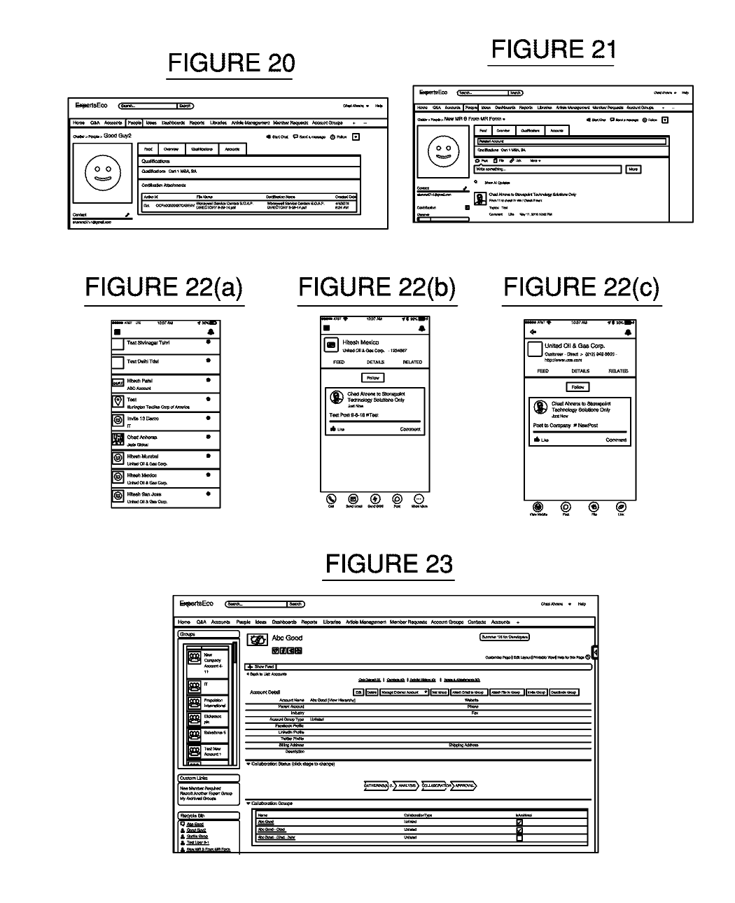

FIG. 18 is a screenshot of a browser page showing connections between experts and customers (Network-to-Customer or “N2C”). The present invention connects experts of multiple companies to customer group members. Specific information about experts and their company capabilities are shared, personalizing the support and fostering relationships between the experts and customers. Features provided by the present invention in this regard include expert and company feeds with on/off line indication provided, the ability to connect using multiple modes of communication, including post, phone, text and email; the ability to post to the company feed and to social media sites such as Facebook, LinkedIn and Twitter. As shown in FIGS. 19 and 20, selection of a person or expert opens their account feed and overview, along with an indication of that person's qualifications and certificates. Posts, photos, videos, files and links from companies and experts are made available (FIG. 21), thereby also creating a space for product marketing. FIGS. 22(a)-22(c) show expert feeds and connections views on a mobile device.

Photos uploaded to the product/asset groups, accounts, and one-owned records also load into the photo gallery. These photos may be used, for example, in a photo rotation display on the calendar. Account and one-owned records have an optional check box to share or not share the photos. The photos may also be used in other areas.

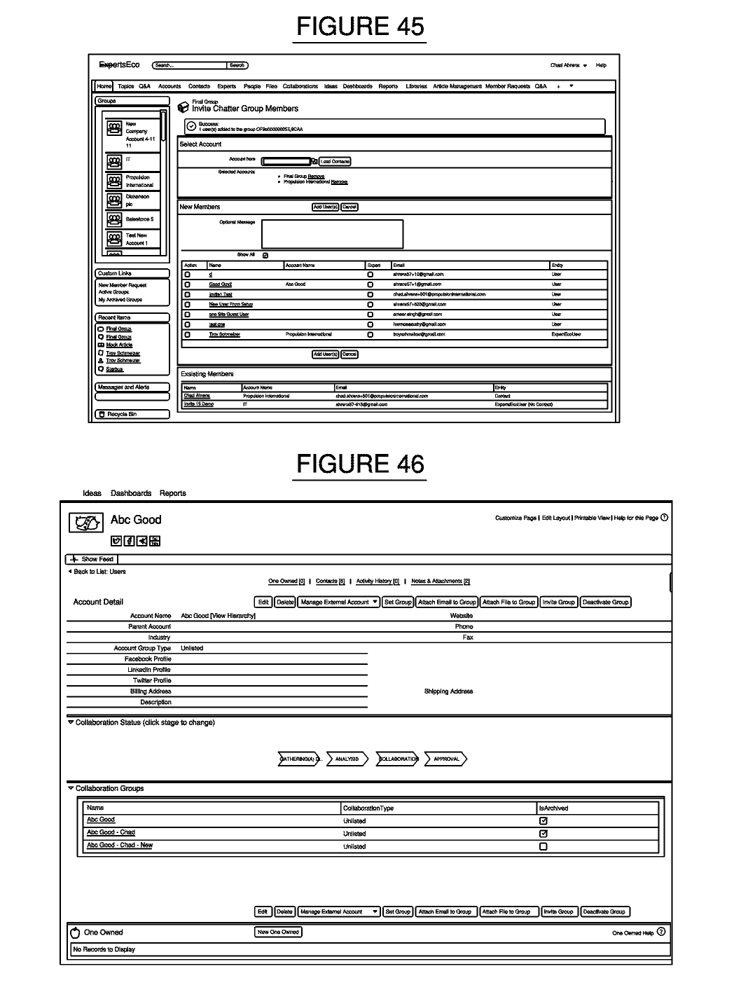

FIG. 23 is an example of an unlisted private collaboration group according to the present invention. Experts have the ability to create temporary unlisted groups with other invited members to collaborate on projects per account, opportunity and or one-owned record. Features such as a customizable progress bar are provided. Conversations are not seen by uninvited members and can be archived with new temporary groups created as needed per account per user. Members are invited using the Group Invite page (see, e.g. FIG. 45). People external from the member system can also be invited with very limited access rights

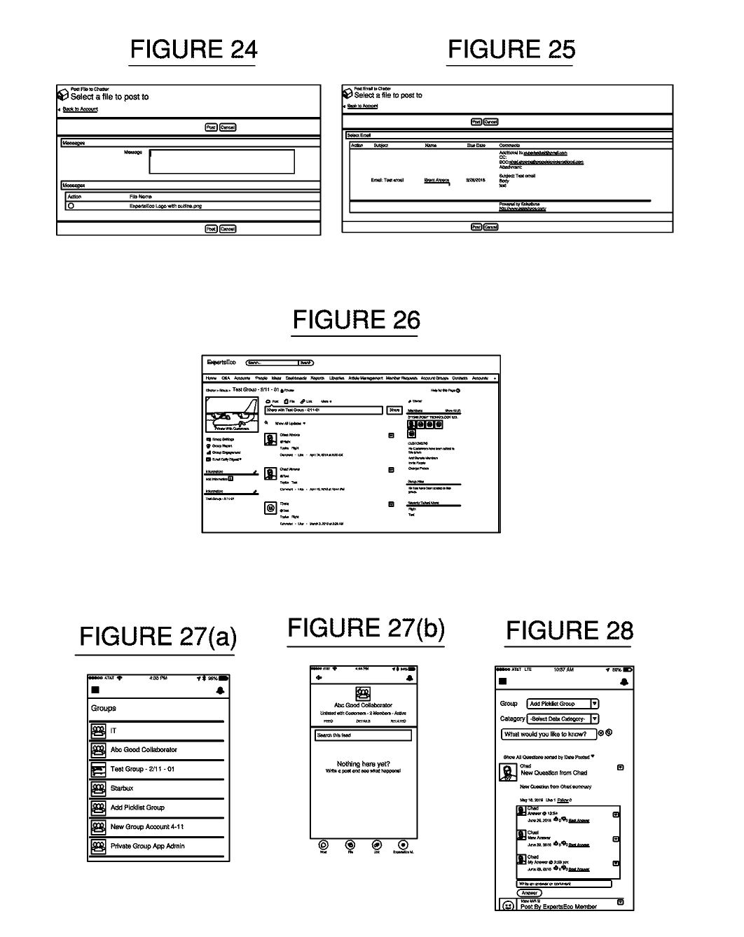

FIGS. 24-25 show selection and attachment of emails and files by a collaborator from their account to be uploaded to a collaboration feed according to the present invention. FIG. 26 shows a group page as viewed on a browser, and FIGS. 27(a)-27(b) show a group page as viewed on a mobile device.

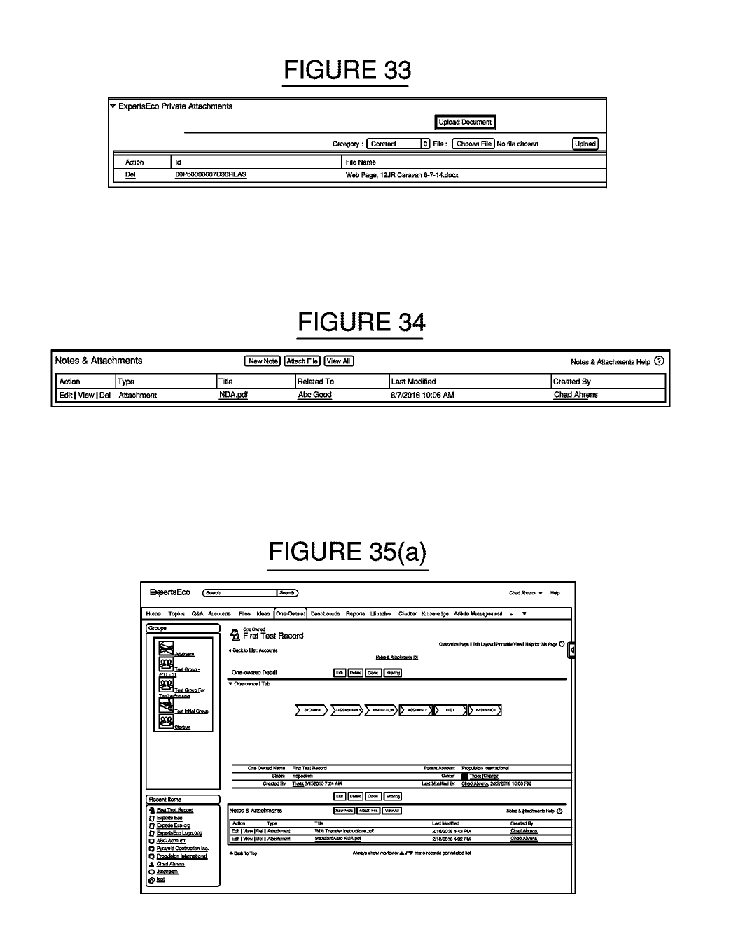

FIGS. 28 (mobile) and 29 (browser) show subject knowledge base pages according to the present invention. A specific knowledge base of articles and attachments on a subject product is uniquely established and maintained only by experts and accredited to the experts. Information is preferably organized by group, product and data categories that are common for the product classification within its industry. Experts can also upload attachments to the ExpertsEco™ library, where they can be viewed by members (FIG. 30). As shown in FIGS. 31 and 32, members attachments are organized by groups and can be accessed by members through files. Members can attach notes and files to their account (FIG. 34), and can make those attachments private if desired (FIG. 33).

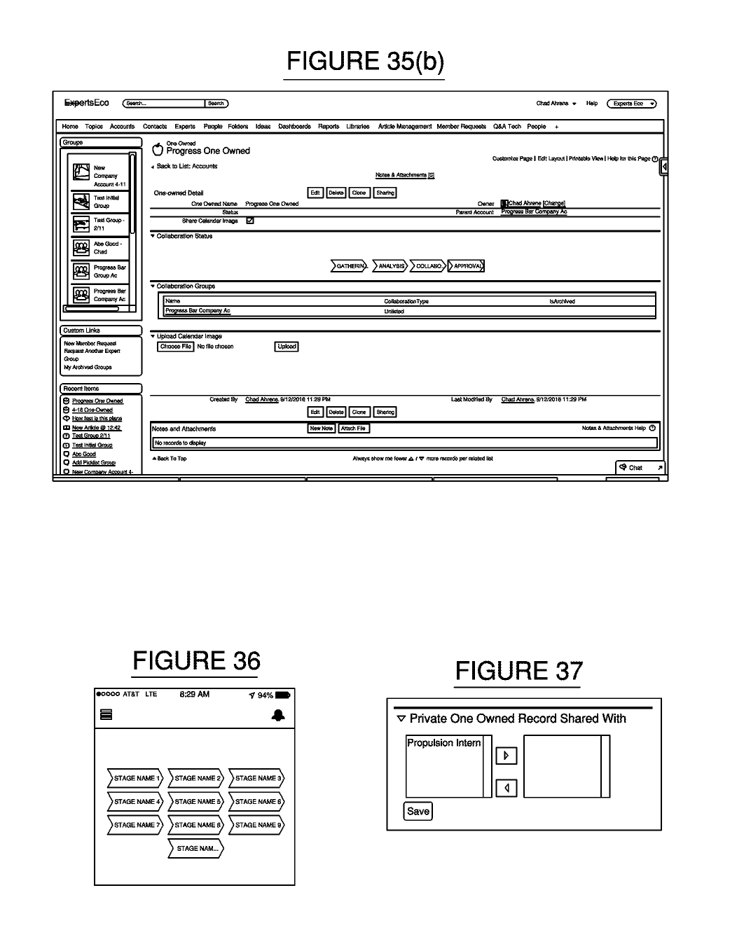

FIGS. 35-36 show a member's customizable One-Owned™ object according to the present invention. The present invention takes the trend toward personalized customer service a step further to the particular product that is owned (the One-Owned™ product) level. Specific information for the product owned by the customer is stored, and via two-way exchange of information, specialized product conditions and configurations remain current and up to date. The customizable One-Owned™ object contains the business logic, database and resulting digital product. Product stage tracking may be provided as well as dashboards, reports and documents referencing the one product that the member owns. At member discretion, One-Owned™ customer information may be shared with experts and companies selected by the member (FIG. 37).

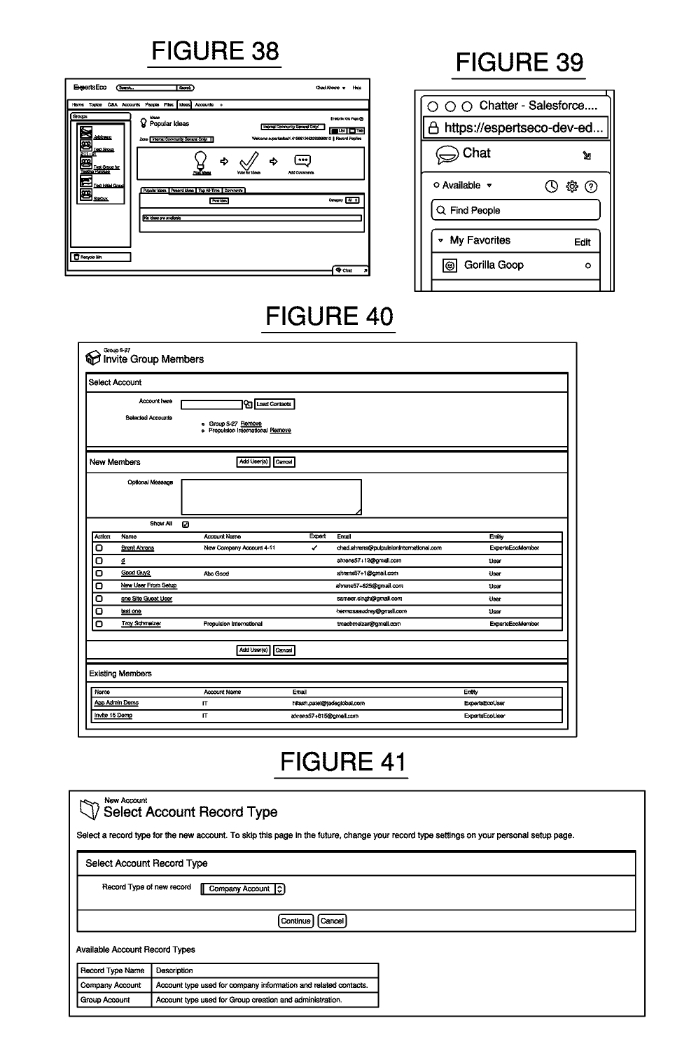

As shown in FIG. 38, and “ideas” page is provided where users may post, vote for and comment on ideas. This feature provides an online, transparent way to attract, manage and showcase innovation. In addition, the present invention provides for live chats between members (FIG. 39).

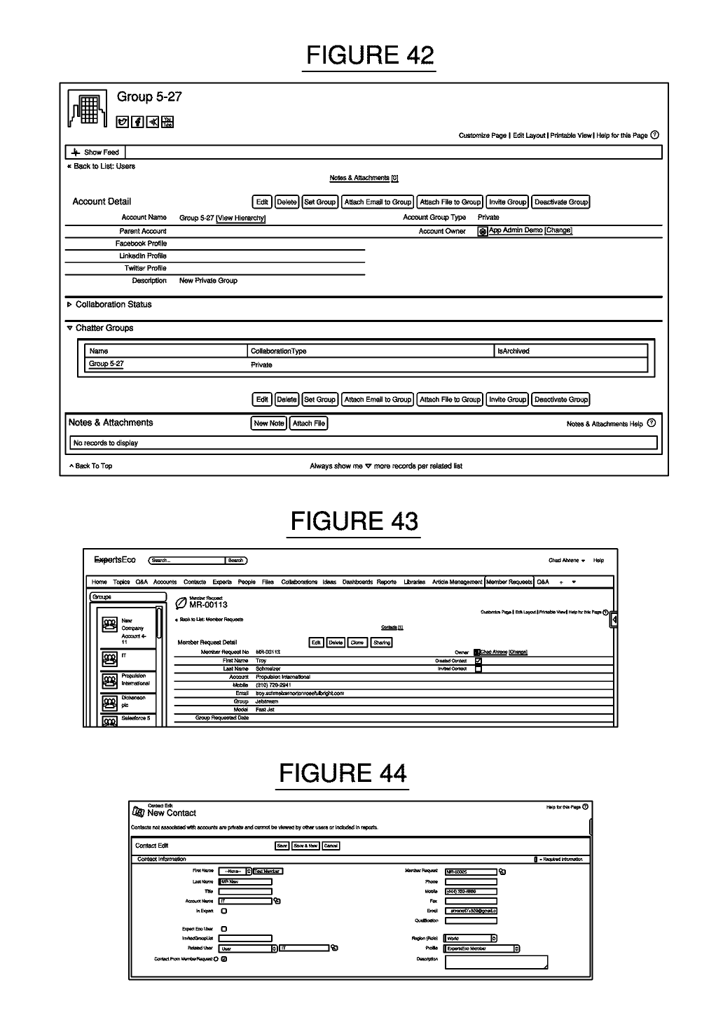

FIGS. 40-46 illustrate features that are accessible by the application administrator or owner only. FIG. 40 depicts a browser page by which an application administrator/owner invites members and grants user access to groups, via approval of a member request form (see FIG. 43). FIG. 41 shows the account view of the application administrator/owner. Here, the application administrator/owner can select and set up group and/or company accounts. A page is provided for the application administrator/owner browser page to manage group accounts (FIG. 42). On receiving a member request form (FIG. 43), the application administrator/owner creates a contact and sets the profile type (license) for the member (FIG. 44). The user is then added/invited to a group of interest the application administrator/owner (FIG. 45). Finally, as shown in FIG. 46, a company account page is provided by which the application administrator/owner can view company information, manage company accounts and manage unlisted collaboration groups.

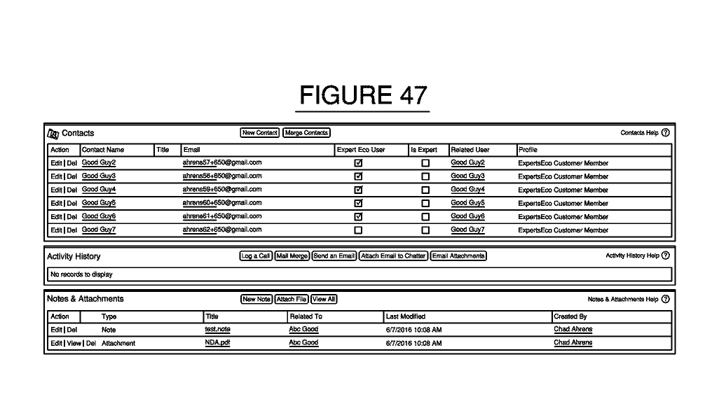

FIG. 47 is a screenshot showing contacts, activity history and notes and attachments according to the present invention.

1. A system for connecting and exchanging information between owners of an asset or product, manufacturers of the asset or product, servicers of the asset or product and experts on the asset or product comprising:
means for creating and managing private groups based on asset or product classification and company;
means for creating and managing private, unlisted groups as collaborations, projects or based on asset or product;
means for managing new members and invitations to groups for new and existing members; and
a digital product object customized to its classification within its industry and that stores a record of specific information and attachments for the asset or product that a customer owns, wherein information about that asset or product, configurations remains up to date via two-way exchange of data with other systems or data entries, on which data analytics are accomplished for a single asset/product or on the aggregated data of many assets/products, reported and charted, and asset/product record(s) can be shared with selected companies within the system.

2. The system of claim 1, wherein the system is implemented as a software application on a cloud computing platform.

3. The system of claim 1, further comprising means for associating qualification and certificates with user profiles.

4. The system of claim 1, further comprising a subject knowledge base page of articles and attachments referencing an asset or product within an industry classification.

5. The system of claim 1, wherein a common group naming protocol synchronizes groups, zones, articles, and new member requests.

6. The system of claim 1, further comprising means for data sharing using and access and share permissions to groups, topics, accounts, files, attachments, dashboards, reports, and digital product records.

7. The system of claim 1, wherein means are provided for owners to socialize in private groups and access knowledge of subject experts.

8. The system of claim 1, wherein private groups are established by product and members are invited to subscribe by the application owner and other members or optional automatic enrollment.

9. The system of claim 1, wherein members connect with manufacturers and service expert companies through group feeds, or directly by phone, text, or email and share a common idea exchange and event calendar.

10. The system of claim 1, wherein feeds are established for companies, experts, products, topics, project collaborations and ideas.

11. The system of claim 1, wherein within the feeds, information such as posts, links, photos, videos and files can be shared and poll requests and announcements may be sent to members.
